(19) United States
(12) Patent Application Publication
(10) Pub. No.: US 2025/0211055 A1
(43) Pub. Date: Jun. 26, 2025

(54) Pump Comprising a Motor Housing and an Electronics Housing Detachably Mounted on the Motor Housing

(71) Applicant: KSB SE & Co. KGaA, Frankenthal (DE)

(72) Inventor: Axel SCHUNK, Frankenthal (DE)

(21) Appl. No.: 18/851,819

(22) PCT Filed: Mar. 24, 2023
(86) PCT No.: PCT/EP2023/057651

§ 371 Date: Sep. 27, 2024

(30) Foreign Application Priority Data
Mar. 29, 2022 (DE) 10 2022 107 373.4

(51) Int. Cl. H02K 5/22; F04D 25/06; H02K 11/33

(52) U.S. Cl. CPC H02K 5/225; F04D 25/06; H02K 11/33

(57) ABSTRACT

A centrifugal pump includes a motor housing, a drive motor, and an electronics housing. The drive motor is mounted inside the motor housing. The electronics housing is fitted on the motor housing. The electrical connection between the drive motor and the electronics is established via a plug-in connection that includes a first plug in part. At least the first plug part is surrounded at least in sections by a plug skirt which is formed by a wall that encircles the first plug part and projects from a base for the housing. The wall projects beyond the first plug part and thereby forms a guide aid for a complementary second plug part when both housings are joined together.

### CROSS REFERENCE TO RELATED APPLICATION

This application claims priority under 35 U.S.C. § 119 from German Patent Application No. 10 2022 107 373.4, filed Mar. 29, 2022, the entire disclosure of which is herein expressly incorporated by reference.

### BACKGROUND

The disclosure relates to a pump, in particular a centrifugal pump, comprising a drive motor mounted inside a motor housing and an electronics housing fitted on the motor housing, wherein the electrical connection between the motor and the electronics is established by means of a plug-in connection comprising a first plug part and a complementary second plug part.

Modern speed-regulated pumps comprise an electromotively operating pump drive. A frequency converter, which is usually accommodated in a dedicated electronics housing, is used to regulate the speed of the pump. The electronics housing is often seated on the periphery or end face of the metallic motor housing. To date, the entire assembly has had to be replaced in the case of a defect in the pump electronics; separate replacement of the electronics or the entire electronics housing was not provided.

### SUMMARY

However, with regard to sustainability, it is desirable to offer better repair options in order to allow for simple replacement of the defective individual components in the case of a defect. This applies in particular to the pump electronics which, as separate components, should be completely replaceable in the case of a defect, ideally even by non-specialist staff or technical laypersons. This requires both a mechanical connection between the electronics housing and the motor housing and the electrical contact-connection between the electronics and the drive to be able to be released and re-established in a simple manner and without manual effort. For this purpose, the electrical connection can be established by means of plug-in connection, for example by means of a first plug part and a complementary second plug part, for example an plug/socket pair. In this case, certain manufacturing tolerances may be problematical, both in the region of the installed housing blanks and the mounting of the plug parts on the respective housing part or the circuit boards/motor turns, and this may result in the plug parts not being exactly aligned with each other during assembly of the pump. This makes plug connection difficult and/or may lead to damage or faulty contact-connection.

Therefore, an improved embodiment of such a plug-in connection which, in the optimum case, can compensate for any manufacturing tolerances and nevertheless ensure mechanical connection is established in a simple manner and readily by technical laypersons is desired.

This object is achieved by a pump according to the features of this specification. The disclosure also relates to advantageous embodiments of the pump.

The disclosure proposes that at least a first plug part is surrounded at least in sections, ideally over the entire circumference, by a plug skirt which is formed by a wall that projects from the housing base. An opening through which the first plug part is accessible from the outside is generally present in the housing wall of the respective housing part (electronics or motor housing). According to the disclosure, the housing surface has, in the opening region, a wall which projects to the outside, for example perpendicularly, from the housing surface and surrounds the plug part over the entire circumference or at least in sections in the form of a plug skirt.

The plug part preferably projects out of the opening, but this does not necessarily have to be the case. An essential point of the disclosure is that the plug skirt formed projects beyond the plug part. In this way, the plug skirt forms a guide aid when the plug parts are joined together since, when the housing parts are joined together, the complementary second plug part of the other housing part first has to be inserted into the interior of the skirt. The plug skirt thus pre-aligns the complementary second plug part until this second plug part comes into contact with the plug part within the skirt when the housing parts are brought together and a connection between the plug parts is established.

The first plug part, which is surrounded by the plug skirt, is preferably fixedly connected to an electronics component within the electronics housing. The plug skirt is therefore formed by a housing surface of the electronics housing. The complementary second plug part is fixedly connected to the motor and passes through an opening in the motor housing to the outside. As an alternative, the first plug part and the plug skirt could be provided on the motor, and the complementary second plug part would then be a fixed constituent part of the electronics within the electronics housing.

It is particularly advantageous when the complementary plug part is mounted in a floating and/or tiltable manner on its housing, in particular on the motor housing. The floating mounting provides additional degrees of freedom for compensating for any positional inaccuracies during plug connection. Floating mounting is ideally performed in the horizontal direction, that is to say transversely to the plug axis. In addition, the plug part can also be mounted in a vertically floating and/or tiltable manner, in particular can be tiltable about a horizontal and/or vertical axis.

As has already been mentioned above, the first plug part is preferably a constituent part of the electronics housing. The electronics housing can generally comprise a heat sink for cooling the power electronics accommodated therein. The electronics housing can be configured in one part or multiple parts. The electronics housing is preferably mounted on the motor housing by means of the heat sink, that is to say the electronics housing rests, by way of the heat sink, on the periphery of the motor housing. The heat sink then has a corresponding opening through which the first plug part is accessible from the outside or is guided through to the outside. Furthermore, the corresponding plug skirt is formed on the base of the heat sink, ideally in the form of an outwardly projecting fin, in the region of the opening in the heat sink.

Encircling play of between 0.3 mm and 1 mm can exist at least in sections between the first plug part and the plug skirt formed. This provides enough space for the complementary second plug part in order to be able to achieve proper pre-alignment. Play of between 0.4 mm at 0.8 mm is preferably enough. Play of approximately 0.5 mm ideally exists between the skirt wall and the first plug part. The play does not have to be constant over the entire periphery, but rather can vary over the periphery. According to a preferred embodiment, most of the play is provided in the region defined above. However, the skirt wall is at a considerably greater distance from the first plug part in at least a subregion, in order to create here additional receiving space for geometries that are formed in the region around the complementary second plug part.

According to one advantageous embodiment of the disclosure, the complementary second plug part can lie within a boundary formed by the base of the housing. Similarly to the plug skirt of the other housing part, such a boundary can surround the complementary second plug part over the entire periphery, but it is essential here for the complementary second plug part to project beyond the boundary. The boundary of the complementary second plug part is preferably dimensioned in such a way that it is likewise inserted into the interior of the plug skirt of the first plug part.

The boundary can surround the complementary second plug part in a manner encircling it at least in sections, with play of between 0.3 mm and 1 mm, preferably of between 0.4 mm and 0.8 mm and ideally of approximately 0.5 mm, being provided here too.

The complementary second plug part can be configured with a fixing surface which projects perpendicularly from the plug axis, in particular a tab-like fixing surface. A shoulder surface formed in the boundary surface serves to support the fixing surface. An additional mechanical connection between the fixing surface and the shoulder surface serves to limit play, in particular axial play. The fixing surface is preferably screw-connected to the shoulder surface.

As already been described above, the plug skirt of the first plug part can have a subregion which forms a recess and can receive geometries during the joining process. The recess can preferably be matched to the shape of the shoulder surface of the boundary of the complementary second plug part, so that the shoulder surface together with the fixing surface and possibly a screw connection can find space within the plug skirt.

Both plug parts can be configured with insertion bevels as additional insertion aids at their outer ends. The insertion bevels can also be formed by draft angles for production-related reasons. The inner skirt wall and/or the outer surface of the boundary of the complementary second plug part can also be provided with insertion bevels.

Further advantages and properties of the disclosure should be explained in more detail below on the basis of an exemplary embodiment illustrated in the figures.

### BRIEF DESCRIPTION OF THE DRAWINGS

FIG. 1: shows a perspective side view of the pump according to the disclosure;

FIG. 2: shows a view of the electronics housing of the pump according to the disclosure from the bottom; pump part;

FIG. 3: shows a plan view of the motor housing together with the hydraulic

FIG. 4a: shows a front view of the front end face of the motor of the pump at the beginning of mounting of the electronics housing;

FIG. 4b: shows a sectional illustration along axis A-A from FIG. 4a;

FIG. 4c: shows an enlarged view of a detail from FIG. 4b;

FIGS. 5a-5c: show the illustrations of FIGS. 4a, 4b, 4c during mounting of the electronics housing and

FIGS. 6a-6c: show the illustrations of FIGS. 4a-4c after mounting of the electronics housing is complete.

### DETAILED DESCRIPTION

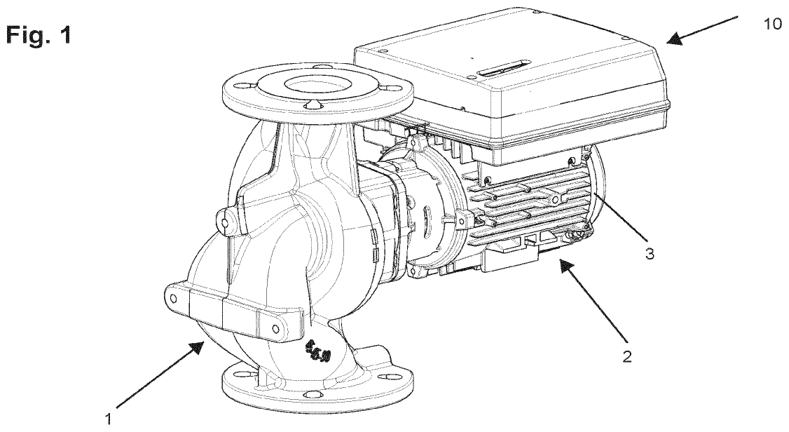

FIG. 1 shows a perspective side view of the pump according to the disclosure, here embodied as a centrifugal pump for example, comprising a hydraulic pump part 1, an electric drive motor 2 with a metallic motor housing 3, and also an electronics housing 10, which is fitted on the periphery of the motor housing 3, for accommodating a frequency converter, as well as a pump controller or pump regulator.

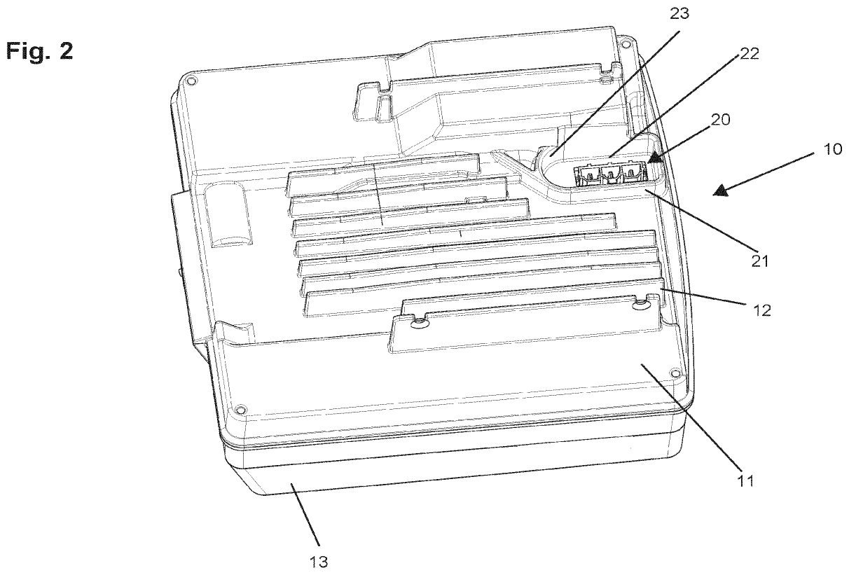

FIG. 2 shows a plan view of the bottom side of the electronics housing 10 for the pump according to the disclosure. The bottom side of the electronics housing 10 is configured as a heat sink 11 which is distinguished by a large number of cooling fins 12 which run in parallel and extend in the direction of the motor housing 3 in the mounted position. The electronics housing 10 is constructed in two parts, specifically from said metallic, in particular aluminum-containing, heat sink 11, in particular aluminum, on the base and a cover part 13, which preferably consists of plastic, placed on the heat sink.

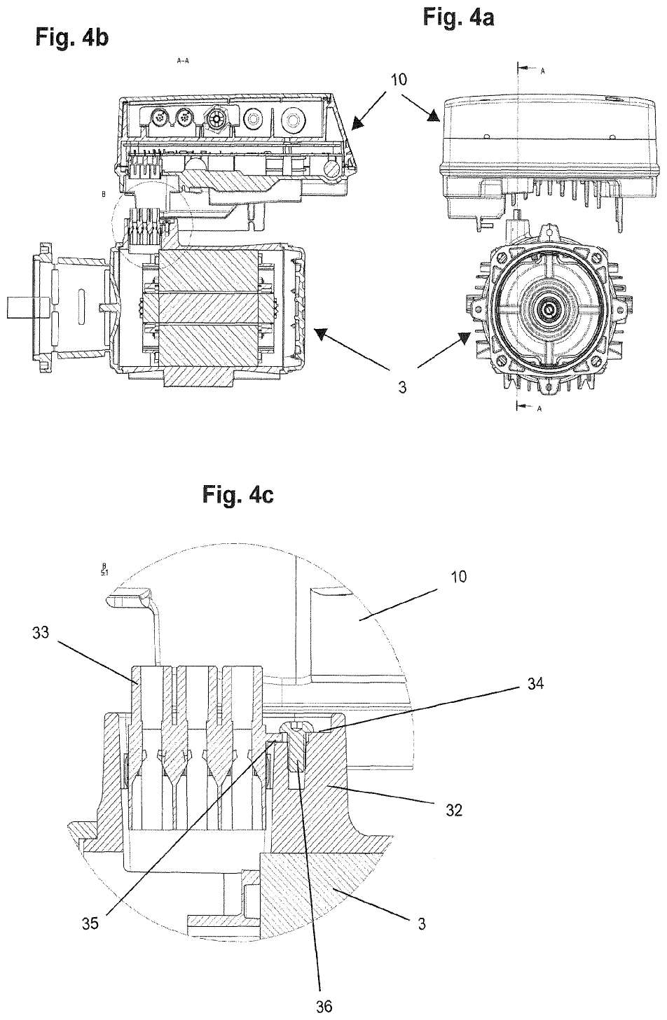

The electronics housing 10 is seated on the periphery of the motor housing 3, and the required electrical contact-connection between the electric drive motor, in particular the stator windings, and the power electronics of the converter is implemented via a detachable plug-in connection. The plug-in connection comprises a plug socket 20 which forms the first plug part, which is associated with the electronics housing 10, and is seated close to the center axis at one end of the housing 10. The plug socket 20 is accessible from the outside via an opening 22 in the heat sink base. A fin-like wall 21 projects to the outside perpendicularly from the base of the heat sink 11 at the opening edge and borders the entire periphery of the plug 20 or the opening 22 and thus forms a skirt 21 which surrounds the socket 20. The skirt 21 projects beyond the socket 20 in the direction of the motor housing 3, this being clearly shown for example in the sectional illustration in FIG. 4c, amongst others.

The distance between the plug skirt 21 and the plug socket 20 is kept constant, apart from a subregion of the skirt 21, and is approximately 0.5 mm. The subregion of the skirt wall is at a considerably greater distance from the plug socket 20, as a result of which additional space for receiving a geometry of the motor housing 3 is created.

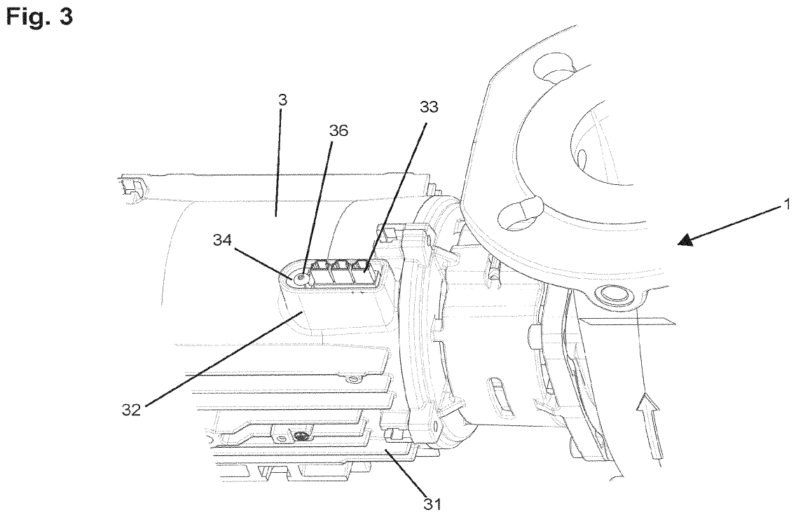

FIG. 3 shows a view of the top side of the motor housing 3 of the pump according to the disclosure with the attached hydraulic part 1. The motor housing 3 is also produced from a metallic material and comprises in subregions of its periphery longitudinal fins 31 for cooling the motor. A kind of pedestal is formed by a perpendicularly formed wall 32 of the motor housing 3 on the peripheral surface of the motor housing 3 that is situated at the top and shown in the illustration. The complementary second plug part 33, which is designed as a male plug here, extends centrally within this wall 32. The second plug part 33 projects beyond the wall 32 in the direction of the electronics housing 10.

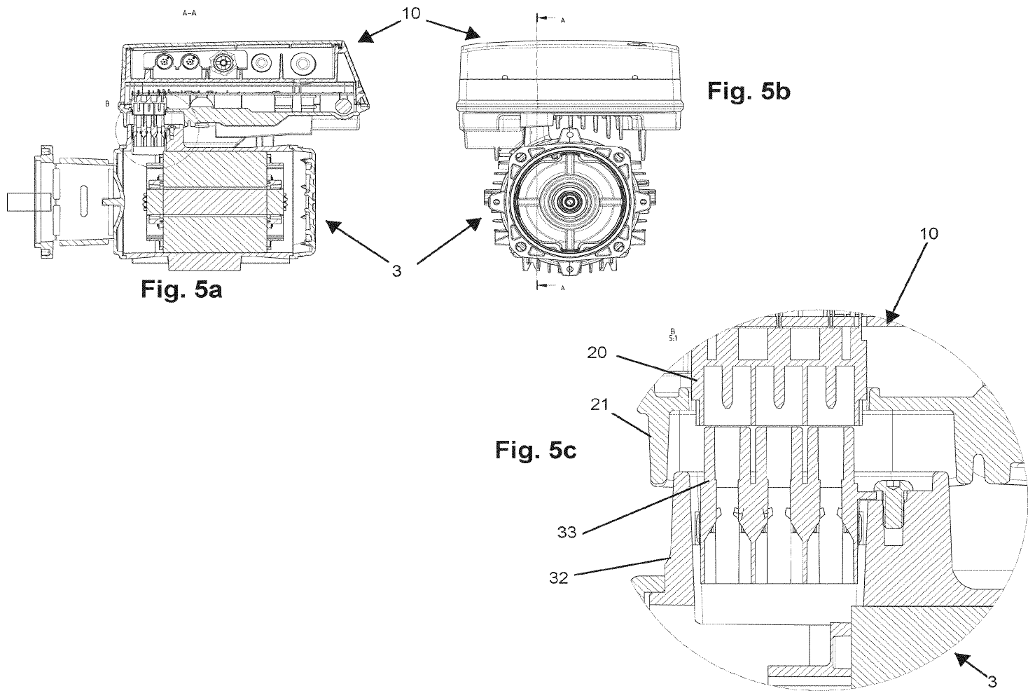

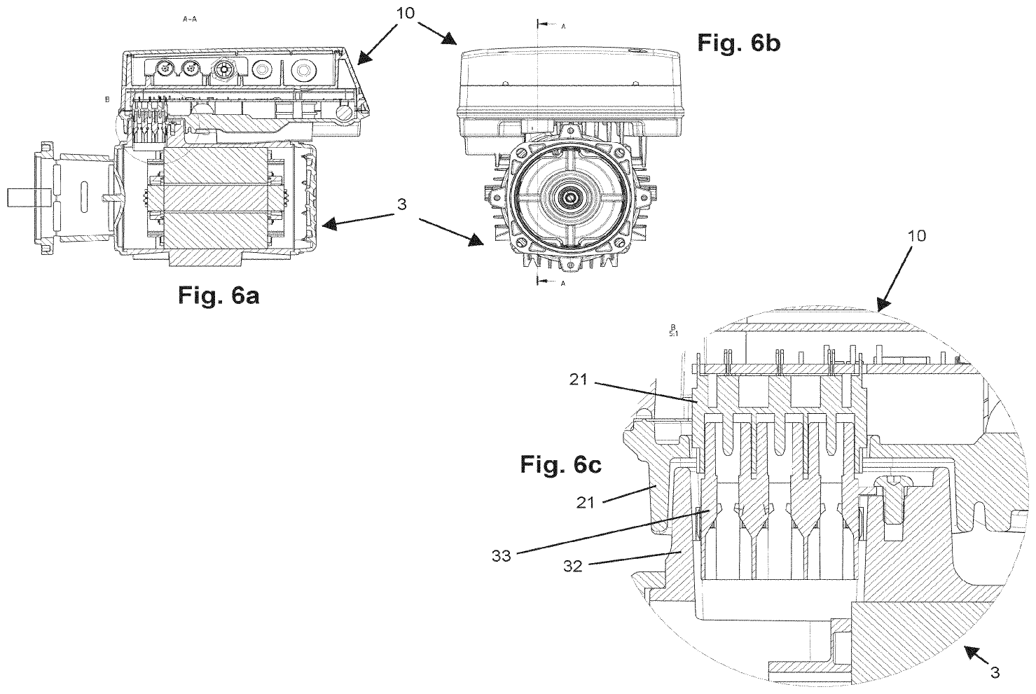

The process of joining together the two housing parts 3, 10 is illustrated in FIGS. 4 to 6, where FIGS. 4a to 4c show the housing parts 3, 10 before the contact-connection, FIGS. 5a to 5c show the housing parts during the joining together process and FIGS. 6a to 6c show the housing parts after plug connection is complete. At the beginning of the assembly process, the plug part 33 and also the bordering wall 32 are inserted into the opening in the skirt 21, so that the plug 33 is pre-centered in relation to the plug socket 20. The outer contour of the wall 32 is matched to the inner contour of the skirt 21.

In addition, the plug 33 is mounted in a floating manner on or within the wall 32, this providing an additional degree of freedom when mutually aligning the plug pair 20, 33. As shown in FIG. 4c for example, the boundary 32 is larger than the periphery of the plug 33. In particular, a shoulder surface 34 is formed. This shoulder surface serves to support a fixing surface 35 which protrudes perpendicularly from the plug wall. The shoulder 34 has a bore in order to screw the fixing surface 35 to the shoulder surface 34 with the aid of the screw 36. The head of the fixing screw 36 presses the fixing surface 35 against the shoulder surface 34, but the outer end of the fixing surface lies at a certain distance from the screw 36, as a result of which a certain amount of horizontal play for floating mounting of the plug 33 is provided. The cutout 23 provided in the skirt 21 creates enough space for receiving the shoulder surface 34 of the motor housing 3.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-10. (canceled)

11. A centrifugal pump, comprising:
a motor housing;
a drive motor mounted inside the motor housing; and
an electronics housing fitted on the motor housing, wherein
an electrical connection between the drive motor and the electronics is established via a plug-in connection that includes a first plug in part,
at least the first plug part is surrounded at least in sections by a plug skirt which is formed by a wall that encircles the first plug part and projects from a base for the housing, and
the wall projects beyond the first plug part and thereby forms a guide aid for a complementary second plug part when both housings are joined together.

12. The centrifugal pump as claimed in claim 11, wherein the complementary second plug part is mounted in a floating and/or tiltable manner floating in a vertical and/or horizontal direction.

13. The centrifugal pump as claimed in claim 12, wherein the first plug part is a constituent part of the electronics housing and the complementary second plug part is a constituent part of the motor housing.

14. The centrifugal pump as claimed claim 13, wherein the first plug part is arranged in a region of a heat sink of the electronics housing, and the plug skirt is formed by a projecting fin of the heat sink.

15. The centrifugal pump as claimed in claim 14, wherein an encircling play at least in sections of between 0.3 mm and 1 mm is provided between the first plug part and the plug skirt.

16. The centrifugal pump as claimed in claim 15, wherein the complementary second plug part lies within a boundary formed by the base of the housing, but the second plug part projects beyond the boundary.

17. The centrifugal pump as claimed in claim 16, wherein an encircling play at least in sections of between 0.3 mm and 1 mm is provided between the second plug part and the boundary.

18. The centrifugal pump as claimed in claim 17, wherein the complementary second plug part comprises a fixing surface which projects perpendicularly from its plug wall, rests on a shoulder surface of the boundary and is securable via a fixing means.

19. The centrifugal pump as claimed in claim 18, wherein the plug skirt has a complementary cutout configured to receive the shoulder surface.

20. The centrifugal pump as claimed in claim 19, wherein the first plug part is a socket or coupling and the complementary second plug part is a plug which is insertable into the socket or coupling.
